(19) United States
(12) Patent Application Publication
(10) Pub. No.: US 2008/0067376 A1
(43) Pub. Date: Mar. 20, 2008

(54) CHARGED PARTICLE BEAM APPARATUS

(76) Inventors: Sayaka Tanimoto, Palo Alto, CA (US); Osamu Kamimura, Kawasaki (JP); Yasunari Sohda, Kawasaki (JP); Hiroya Ohta, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/751,094

(22) Filed: May 21, 2007

(30) Foreign Application Priority Data
May 25, 2006 (JP) 2006-144934

(51) Int. Cl. G21K 7/00

(52) U.S. Cl. 250/310

(57) ABSTRACT

This invention provides a charged particle beam apparatus that can makes reduction in off axis aberration and separate detection of secondary beams to be compatible. The charged particle beam apparatus has: an electron optics that forms a plurality of primary charged particle beams, projects them on a specimen, and makes them scan the specimen with a first deflector; a plurality of detectors that individually detect a plurality of secondary charged particle beams produced from the plurality of locations of the specimen by irradiation of the plurality of primary charged particle beams; and a voltage source for applying a voltage to the specimen. The charged particle beam apparatus further has: a Wien filter for separating paths of the primary charged particle beams and paths of the secondary charged particle beams; a second deflector for deflecting the secondary charged particle beams separated by the Wien filter; and control means for controlling the first deflector and the second deflector in synchronization, wherein the plurality of detectors detect the plurality of secondary charged particle beams separated by the Wien filter individually.

### CLAIM OF PRIORITY

The present invention claims priority from Japanese application JP 2006-144934, filed on May 25, 2006, the content of which is hereby incorporated by reference on to this application.

### BACKGROUND OF THE INVENTION

This invention relates to a charged particle beam application technology, and more specifically, to a charged particle beam apparatus used in a semiconductor process and the like, such as an inspection apparatus and measurement apparatus.

In the semiconductor process, there are used an electron microscope, an electron beam inspection system, etc. each of which irradiates a charged particle beam (hereinafter referred to as a primary beam), such as an electron beam and an ion beam, on an object to inspect a shape of a pattern formed on the object and existence/non-existence of a defect from a signal of produced secondary charged particles (hereinafter referred to as a secondary beam), such as secondary electrons.

In the semiconductor manufacturing equipments that applies these electron beam etc., it is an important task, as well as improvement in precision, to improve a speed at which the object is processed, i.e., a throughput. In order to attain this task, for example, Japanese Patent Application Laid-Open No. 2002-141010 and others proposes a multi-electron-beam apparatus that irradiates an electron beam emitted from a single electron gun on a plate having a plurality of openings, projects reduced images of the openings on a specimen using a lens and a deflector both provided downstream of the plate, and scans the images on the specimen.

On the other hand, Japanese Patent Application Laid-Open No. 2001-267221 proposes a multi-beam charged particle beam exposure system that divides a charged particle beam emitted from a single charged particle source by irradiating it on a plate having a plurality of openings, forms a plurality of intermediate images of the charged particle source by focusing them individually with lenses arranged in an array, and projects and scans the plurality of intermediate images on the specimen using a lens and a deflector provided downstream of the intermediate images.

By comparing the two system from a viewpoint of a throughput, it can be said that the latter, which is capable of collecting an electron beam widened in angle with lenses arranged in an array, is advantageous over the former because a current that can be made to reach the specimen is large.

### SUMMARY OF THE INVENTION

In the case where, for example, a shape of a semiconductor pattern etc. and existence/non-existence of a defect are inspected using the multi-charged-particle-beam apparatus that forms a plurality of primary beams, as described above, and projects and scans them on a specimen with common optical elements, what would be a problem is reduction of off-axis aberrations that are produced by the plurality of primary beams drawing trajectories away from centers of optical elements, such as a lens. Another problem is separate detection of a plurality of secondary beams that are emitted from a plurality of locations on the specimen by the plurality of beams being irradiated.

These two problems are in a relation of trade-off. That is, from a viewpoint of aberration of the primary beams, it is desirable that a plurality of beams have as narrow intervals as possible. In contrast to this, from a viewpoint of separate detection of the secondary beams, it is preferable that the plurality of beams have as wide intervals as possible, and specifically the intervals must be larger than at least resolution of a secondary electron optics.

The present invention has as its object to provide a charged particle beam apparatus that realizes compatibility between reduction in the aberration of the primary beams and separate detection of the secondary beams.

In order to attain the object, in this invention, a charged particle beam apparatus is provided with a deflector that acts only on the secondary beams. Using this deflector, a fluctuation of the position of the secondary beam image in a detector produced by scanning of the primary electrons is canceled.

Moreover, in this invention, the detector or an element for separating the secondary beams is installed on a pupil plane of the primary beams.

Furthermore, in this invention, in order to install an electrode for controlling the surface field strength of a specimen in the extreme vicinity of the specimen, warping of the specimen is corrected with an electro static chucking device.

Still Moreover, in this invention, aberration of the primary beam irradiated onto the specimen is reduced by individually adjusting focal lengths of lenses adapted to individually focus a plurality of electron beams.

### BRIEF DESCRIPTION OF THE DRAWINGS

These and other features, objects and advantages of the present invention will become more apparent from the following description when taken in conjunction with the accompanying drawings wherein:

FIG. 1 is a diagram for explaining a configuration of a multi-electron-beam inspection system according to a first embodiment of the present invention;

FIG. 2 is a diagram for explaining a structure of a lens array in the first embodiment;

FIG. 3 is a diagram for explaining an electro static chucking device, a specimen, and a surface field control electrode in the first embodiment;

FIGS. 4A, 4B, and 4C are diagrams for showing electrodes in the first embodiment; in which FIG. 4A shows a surface field control electrode, FIG. 4B shows a height detection function, and FIG. 4C shows a surface field control electrode of a multiple opening type;

FIGS. 5A and 5B are diagrams for explaining raster scan; in which FIG. 5A shows a case of five primary beams, and FIG. 5B shows a case of eight primary beams;

FIGS. 6A and 6B are diagrams for explaining an effect of a deflector in the first embodiment; in which FIG. 6A shows a case without re-deflection, and FIG. 6B shows a case with re-deflection;

FIG. 7 is a diagram for explaining a configuration of a multi-electron-beam inspection apparatus according to a second embodiment of the present invention;

FIGS. 8A and 8B are diagrams for showing trajectories of beams in an objective lens; in which FIG. 8A shows trajectories of primary beams, and FIG. 8B shows trajectories of secondary beams;

FIGS. 9A and 9B are diagrams for explaining a separate detection method of the secondary beams in the second embodiment;

FIGS. 10A and 10B are diagrams for explaining optical elements in the second embodiment; in which FIG. 10A shows a deflector array, and FIG. 10B shows a cylindrical separation element;

FIGS. 11A and 11B are diagrams for explaining a principle of correcting curvature of image field in a third embodiment of this invention; in which FIG. 11A shows a case of curvature of image field, and FIG. 11B shows a case of correction of the curvature of image field;

FIG. 12 is a diagram for explaining a structure example of a lens array in the third embodiment;

FIGS. 13A, 13B, and 13C are diagrams for explaining another structure example of the lens array in the third embodiment; in which FIG. 13A shows a structure of a lens array, FIG. 13B shows another electrode separation method for eight primary beams, and FIG. 13C shows further another electrode separation method for 4×4 primary beams; and

FIG. 14 is a diagram for explaining a configuration of a single-beam electron beam inspection apparatus according to a fourth embodiment of this invention.

### DETAILED DESCRIPTION OF THE PREFERRED EMBODIMENTS

Hereafter, embodiments of this invention will be described in detail with reference to the drawings. In all the figures for explaining embodiments, principally the similar members are given the same reference numerals and their repeated explanations are omitted.

### First Embodiment

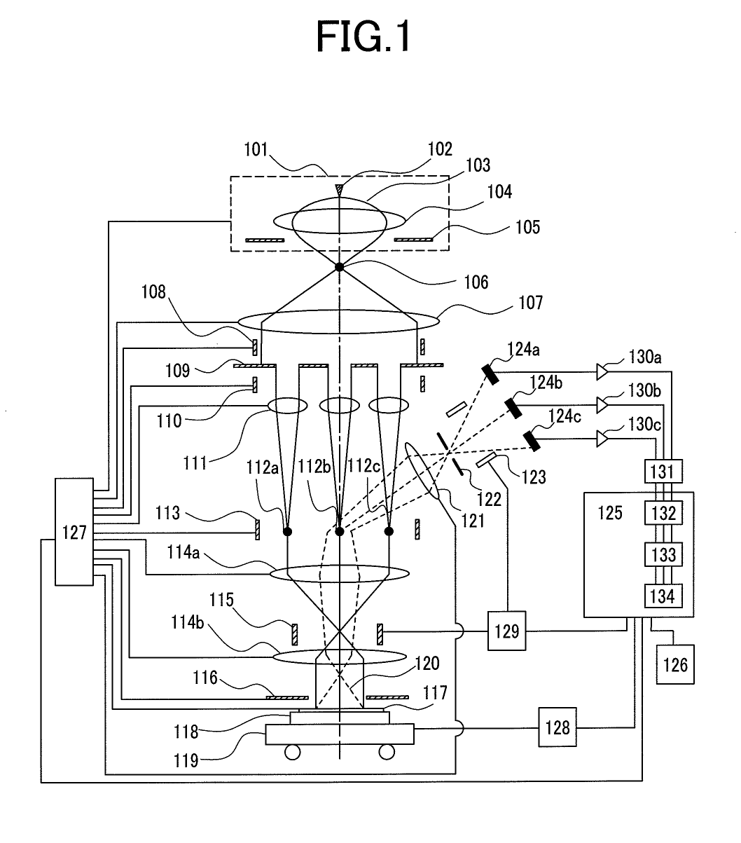

FIG. 1 is a diagram for showing a schematic configuration of a multi-electron-beam inspection system according to a first embodiment of this invention. This apparatus is broadly divided into a primary electron optics for controlling primary beams (primary charged particle beam) 103 that is emitted from a cathode 102 and reaches the specimen 117, and a secondary electron optics for controlling secondary beams (secondary charged particle beam) 120 produced by interaction between the primary beams and the specimen 117. An alternate long and short dash line denotes an axis with which a symmetry axis of the primary electron optics formed substantially in rotation symmetry should coincide and that serves as a reference of the primary beam path. Hereinafter it is called a central axis.

An electron gun 101 includes the cathode 102 made of a material whose work function is low, an anode 105 having a high electric potential to the cathode 102, a magnetic lens 104 for superimposing a magnetic field on an acceleration electric field formed between the cathode 102 and the anode 105. This embodiment uses a Schottky cathode that easily delivers a large electric current and is also stable in electron emission. A primary beam 103 emitted from the cathode 102 is accelerated in a direction of the anode 105 while receiving a focusing action by the magnetic lens 104.

A reference numeral 106 denotes a first image of source. A condenser lens 107 shapes the primary beam to a substantially collimated beam by using this first image of source 106 as a light source. In this embodiment, the condenser lens 107 is a magnetic lens. A reference numeral 109 is an aperture array in which openings are arranged on the same substrate two-dimensionally, dividing the primary beam into a plurality of beams. In this embodiment, the aperture array has five openings that divide the primary beam into five beams. Among these beams, the one is arranged on the central axis and the remaining four are arranged at positions equidistant from the central axis. FIG. 1 illustrates three beams out of them. Reference numerals 108, 110 are aligners each for adjusting a traveling direction of the primary beam.

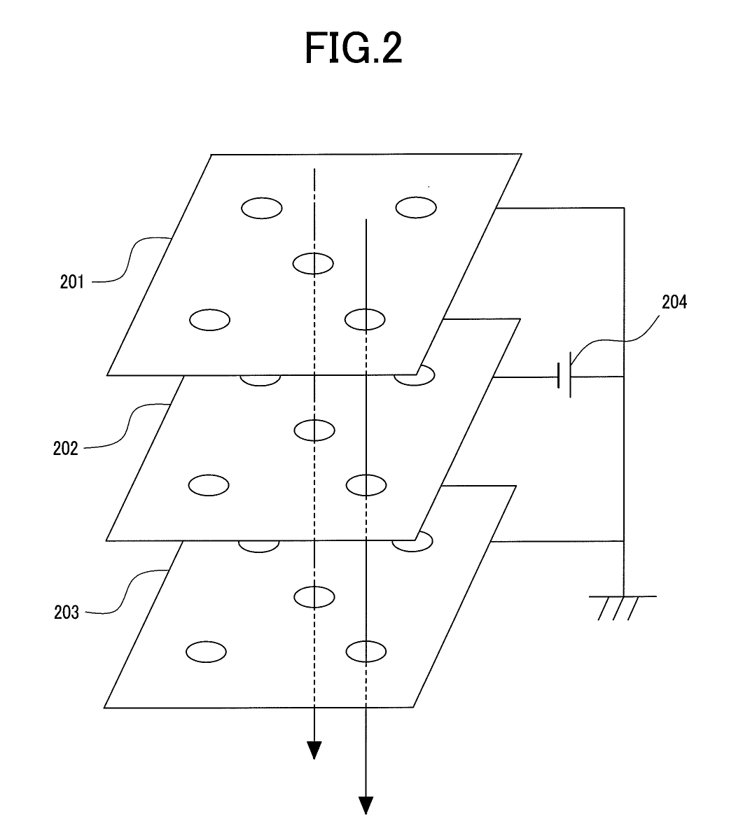

The divided primary beams are individually focused by a lens array 111. Here, FIG. 2 is a schematic diagram for showing a structure of the lens array 111. It broadly includes three electrodes: an upper electrode 201, a middle electrode 202, and a lower electrode 203. Each electrode has a plurality of openings. The opening has a circular shape. For example, the openings of the electrodes are aligned on a straight line parallel to the central axis (represented by an alternate long and short dash line) to constitute a single electron lens as shown by an arrow. A common potential (in this example, earth potential) is connected to the upper electrode 201 and the lower electrode 203, and a voltage source 204 is connected the middle electrode, applying thereto a different potential. This configuration acts as an einzel lens on the primary beam passing through the openings, and forms a plurality of second images of source 112a, 112b, and 112c.

The five primary beams individually focused by the lens array 111 pass through the inside of a Wien filter 113. The Wien filter 113 generates mutually orthogonal magnetic field and electric field in a plane substantially perpendicular to the central axis, and thereby gives an electron passing therethrough a deflection angle corresponding to its energy. In this embodiment, the strengths of the magnetic field and the electric field are set up so that the primary beams may travel straight. However, since each primary beam has an energy spread of about a few electron volts, an angular spread is generated in the primary beam by its passing through the Wien filter 113. In order to reduce defocusing of the primary beam on the specimen 117 that results from this spread to be as small as possible, a group of trajectories coming out of a single point of a deflection principal plane of the Wien filter 113 should just converge to a single point on the specimen 117. Therefore, as shown in FIG. 1, it is optimal to bring the deflection principal plane of the Wien filter 113 into agreement with a plane defined by focusing points of the second images of source 112a, 112b, and 112c.

Reference numerals 114a, 114b are one pair of objective lenses, and each objective lens is a magnetic lens. This pair of objective lenses has an action of reduction projecting the second images of source 112a, 112b, and 112c on the specimen 117.

A reference numeral 119 denotes a movable stage, which is controlled by a stage control 128. A pallet 118 is placed and held on this stage. An electro static chucking device built in the inside of the pallet 118 holds the specimen 117, and corrects the specimen 117 that has become a convex or concave of a size of a few tens of μm after undergoing a process of film formation etc. to be a flat chucking plane.

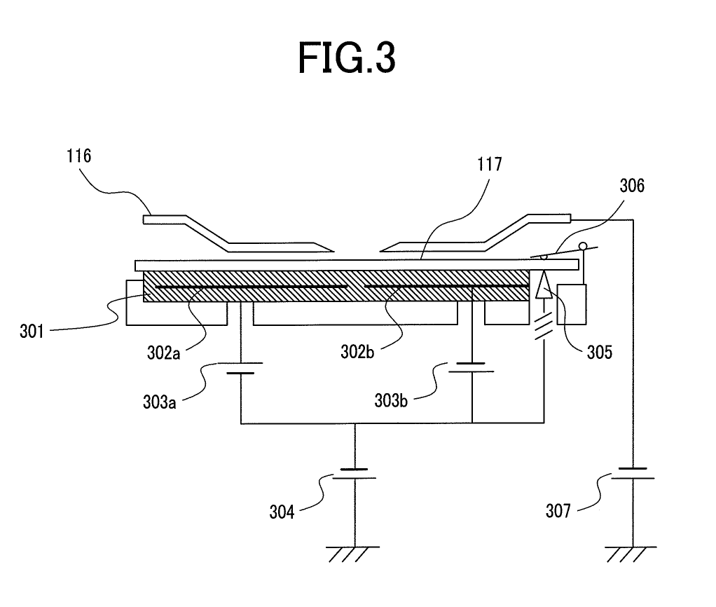

FIG. 3 is a diagram for explaining the electro static chucking device built in the pallet 118, the specimen 117 held by this device, and a surface field control electrode 116 installed in the vicinity of the specimen 117. A reference numeral 301 is a dielectric whose main material is alumina, and reference numerals 302a, 302b are chucking electrodes embedded in the dielectric 301. The chucking electrode 302a is connected with a (+) side of a direct current voltage source 303a. The chucking electrode 302b is connected with a (−) side of a direct current voltage source 303b. The electro static chucking device in which the chucking electrode is divided into two like this is called a dipole type.

The surface of the specimen 117 is clamped with a pressing fixture 306 so that it may not come floating, and a contact pin 305 having an acute acicular shape is pressed to the backside thereof by the force of a spring. A retarding voltage source 304 is connected to the contact pin 305, by which a negative voltage for decelerating the primary beam is applied to the specimen 117.

On the other hand, both the (+) side of the direct current voltage source 303a and the (+) side of the direct current voltage source 303b are both connected to the (−) side of the retarding voltage source 304 built in an electron optics control 127. That is, the specimen 117 and the chucking electrode 302a act as a pair of electrode; the specimen 117 and the chucking electrode 302b act as a pair of electrodes. The dielectric 301 sandwiched by these pairs of electrodes is applied with a voltage. By this structure, the dielectric is made to generate charges by dielectric polarization, whereby an electrostatic chucking force is secured.

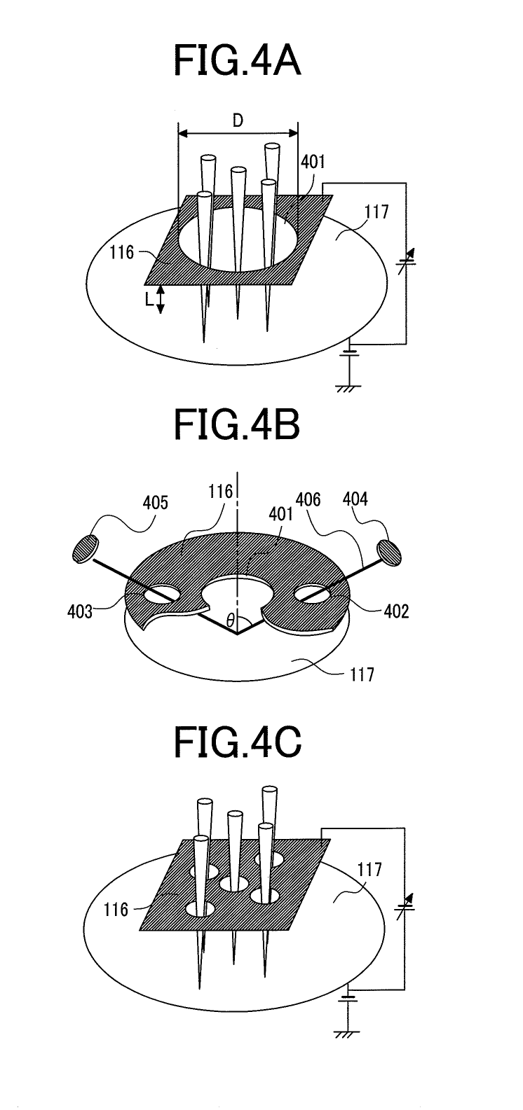

FIG. 4A is a diagram for explaining the surface field control electrode 116. The surface field control electrode 116 is an electrode for adjusting the electric field strength near the surface of the specimen 117 and controlling a trajectory of the secondary beams. The surface field control electrode 116 is installed facing the specimen 117, is equipped with a circular opening 401 that allows the primary beam and the secondary beam to pass therethrough, and is applied with a positive potential, a negative potential, or the same potential to the specimen 117 by a voltage source 307. The voltage applied across the specimen 117 and the surface field control electrode 116 shall be adjusted to a suitable value depending on the type of the specimen 117 and an observation object. For example, the secondary beam produced from the specimen is positively intended to return to the specimen, a negative potential is applied to the surface field control electrode 116 with respect to the specimen 117. On the contrary, a positive potential can be applied to the surface field control electrode 116 with respect to the specimen 117 so that the secondary beam may not return to the specimen 117.

On the other hand, the surface field control electrode 116 has a lens action to the primary beam. Therefore, in this embodiment, the four beams among the five beams, except the one formed on the central axis, will pass through locations away from the center of a lens formed by the surface field control electrode 116. By this geometry, since off-axis aberrations, i.e., astigmatism, coma aberration, and curvature of image field occur, an image becomes defocused when it reaches the specimen 117.

In this invention, in order to reduce these aberrations, the surface field control electrode 116 is installed in the extreme vicinity of the specimen 117, and a time required for the primary beam to pass through an electric field formed by the surface field control electrode 116 is shortened. That is, a distance L between the surface field control electrode 116 and the specimen 117 is shortened. Preferably, L shall be 1 mm or less. At this time, if the specimen 117 has a warping, the surface field strength cannot be fully controlled. Moreover, when the warping is large, the surface field control electrode 116 is likely to contact the specimen 117, giving a flaw. Then, in this embodiment, in order to hold the specimen, the electro static chucking device that has a function of correcting the specimen to be a flat chucking plane.

An opening diameter D of the surface field control electrode 116 should be determined considering the electric field strength required to form on the specimen surface and the aberrations of the primary beam. After consideration of the aberrations of the primary beam, it was found that the opening diameter D one to four times as large as the distance L between the surface field control electrode 116 and the specimen 117 was preferable. In this embodiment, the distance L between the surface field control electrode 116 and the specimen 117 is specified to be 300 μm, and the opening diameter D of the surface field control electrode 116 is specified to be 100 μm.

Although not shown in FIG. 1, a specimen height detection mechanism using a beam is provided in this embodiment. FIG. 4B is a diagram for explaining the height detection mechanism. A laser source 404 for height detection irradiates a laser beam 406 onto the specimen 117, and a position sensor 405 receives the laser beam 406 reflected by the specimen 117 to detect the height of the specimen 117 from a receiving position of the beam. The detected height is fed back to lens power of the objective lens 114a or 114b through the electron optics control 127. As a result, the primary beam is focused on the specimen 117 irrespective of the height of the specimen 117. The incident angle θ of the laser beam 406 to the surface of the specimen 117 is approximately 80° in this embodiment. Here, since the distance L between the surface field control electrode 116 and the specimen 117 is 300 μm in this embodiment, a position at which the laser beam 406 crosses the surface field control electrode 116 is a position approximately 1700 μm away from the central axis, shown by an alternate long and short dash line. On the other hand, since the opening diameter D of the surface field control electrode 116 is 1000 μm, the laser beam 406 cannot pass through the inside of the opening 401. To cope with this problem, by providing openings 402, 403 for laser beam in the surface field control electrode 116, the height detection mechanism is realized.

Note that although in this embodiment, a configuration such that a plurality of primary beams were allowed to pass through a single opening of the surface field control electrode 116 was taken, a configuration such that a plurality of openings is provided in the surface field control electrode 116 as shown in FIG. 4C and the plurality of primary beams are allowed to pass through respective different openings may be adopted. Since a shape and a position of the opening of the surface field control electrode 116 can be set up for each of the plurality of primary beams, a merit of this configuration is that it is easy to control an effect of an electric field formed by the surface field control electrode 116 and the specimen 117 upon the primary beam.

Moreover, although the opening shape of the surface field control electrode 116 is made a circle in this embodiment, there may be a case where a shape of an ellipse, a polygon, etc. has the same effect.

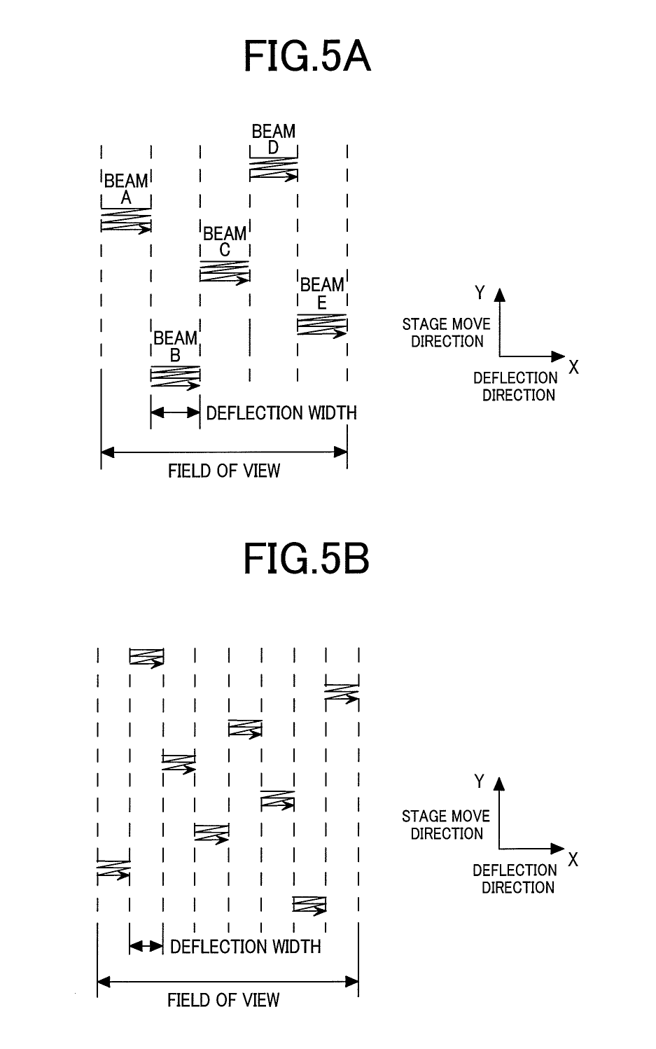

Now, to return to the description of FIG. 1 again. An electrostatic eight-pole deflector 115 is installed in the objective lens. When a signal is inputted into the deflector 115 by a scanning signal generator 129, a plurality of primary beams passing through the inside thereof receive a deflection action, substantially in the same direction and by substantially the same angle, and performs raster scan on the specimen. FIG. 5A is a diagram for explaining raster scan of the primary beam in this embodiment. Trajectories of five primary beams A, B, C, D, and E on the specimen are shown by respective arrows. At an arbitrary time point, when locations of the five primary beams A, B, C, D, and E are projected on the X-axis, they are spaced at regular intervals. Each beam performs raster scan on the specimen 117 with a width (deflection width) substantially equal to this interval s. At the same time, the stage 119 moves in the Y-direction. A system control 125 systematically controls the scanning signal generator 129 and the stage control 128 so that the five primary beams scan a field of view (FOV) that is five times s, from one end to the other end. Note that irrespective of the number of primary beams, the sample can be raster-scanned thoroughly with a plurality of primary beams. What is shown in FIG. 5B is an example of a case of eight primary beams.

The five primary beams that reach the specimen interact with a matter near the surface of the specimen. By this interaction, secondarily generated electrons, such as back-scattered electrons, secondary electrons, and Auger electrons, are produced from the specimen. A flow of these secondary electrons is hereinafter called the secondary beam.

A negative potential for decelerating the primary beam is applied to the specimen 117 by the retarding voltage source. This potential has an acceleration action to the secondary beam having a direction of movement contrary to that of the primary beam. The secondary beam receives an acceleration action and subsequently receives a focusing action of the objective lenses 114a, 114b. The Wien filter 113 has a deflection action to the secondary beam. By this action, the trajectory of the secondary beams is separated from the trajectory of the primary beams.

Here, the secondary beams produced by the interaction between the primary beams and the specimen has a spread in energy or in angle. In order to independently detect the secondary beams produced from five locations, it is required that the secondary beams produced from the five locations reach detectors, without mixing mutually. To realize this, the secondary beam that spread in terms of energy and angle is focused using an electrostatic lens 121. At this time, lens power that should be given to the electrostatic lens 121 is determined by the following factors: trajectories of the secondary beams from the specimen 119 to the Wien filter 113; a deflection angle given to the secondary beams by the Wien filter; the voltage applied to the specimen 119; arrangement of detectors 124a, 124b, and 124c; etc. Therefore, like the other optical elements, the electrostatic lens 121 is systematically controlled by the electron optics control 127.

Note that although the electrostatic lens was used for focusing the secondary beams in this embodiment, the use of a magnetic lens can attain the same effect.

A reference numeral 122 denotes an aperture for intercepting a part of the secondary beams, and optimally is installed at a position at which the secondary beams produced from the five locations gather.

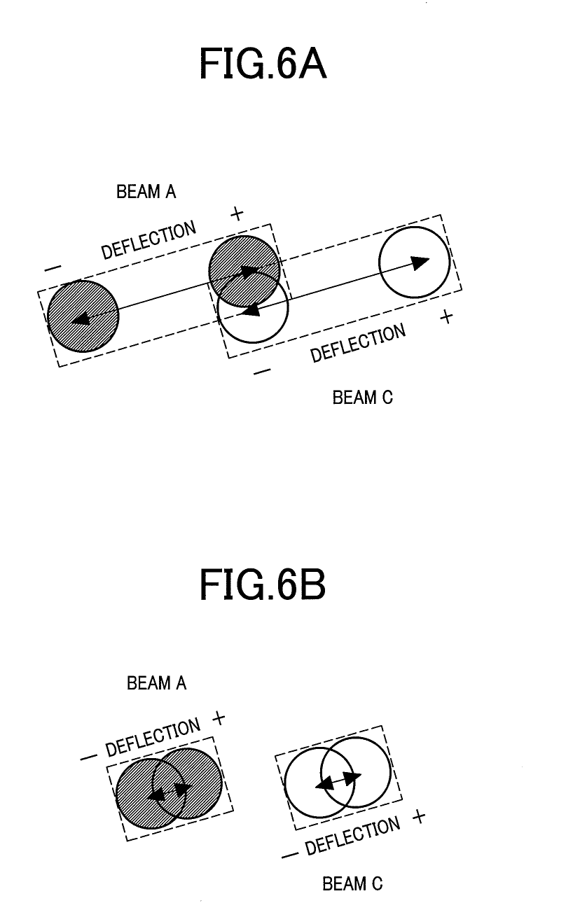

A reference numeral 123 denotes a re-deflection deflector for deflecting the secondary beams. FIGS. 6A and 6B are diagrams for explaining an effect of this re-deflection deflector 123, showing a position and a size of the secondary beams on a detector plane that is produced by the interaction between beam A and beam C that are adjacent beams among the five primary beams illustrated in FIG. 5A and the specimen 117.

As already described, the primary beams is deflected by the deflector 115 and is raster-scanned on the specimen. Therefore, positions at which the secondary beams are produced on the specimen varies in synchronization with the scan. Further, since the secondary beams produced from the specimen is accelerated and subsequently passes through the inside of the deflector 115, it receives a deflection action. Therefore, the secondary beam produced by the same primary beam does not necessarily reach the same point on the detector plane. FIG. 6A shows positions of the secondary beams on the detector plane when re-deflection is not performed, showing that when the primary beams receives an action of the deflector 115 to scan the specimen from the negative direction to the positive direction of the X-direction, a position of the secondary beams on the detector plane varies in synchronization with it. For this reason, the secondary beam produced by beams A scanned to the positive direction and the secondary beam produced by beam C scanned to the negative direction reach very close positions on the detector plane. There is a case where the two beams overlap depending on optical conditions. Consequently, it is impossible to install both the detector for detecting the secondary beams produced by beam A and the detector for detecting the secondary beam produced by beam B so that the two detectors may not interfere each other.

In contract to this, FIG. 6B shows positions of the secondary beams on the deflector plane in the case where the deflector 123 is inputted a signal in synchronization with the deflector 115 by the scanning signal generator 129 and the secondary beams are re-deflected. On the detector plane, the secondary beams produced by beams A and the secondary beam produced by beam C reach approximately fixed positions irrespective of scanning of the primary beam. Thanks to this feature, both the detector for detecting the secondary beam produced by beam A and the detector for detecting the secondary beam produced by beam B were able to be installed so that the two detectors may not interfere each other.

Note that in this embodiment, since the electrostatic deflector was used as the deflector 115, in order to attain the equivalent response speed, the electrostatic deflector was used also for the deflector 123, but that a magnetic deflector may be used in the case where the deflection speed is sufficiently slow, or where re-deflection precision is not important, or the like.

The signals detected by the detectors 124a, 124b, and 124c are amplified by amplifiers 130a, 130b, and 130c, and are digitized by an AD converter 131, respectively. The digitized signals are temporarily stored in memory 132 in the system control 125 as image data. Then, a computer 133 calculates various statistics of the images, and, finally determines existence/non-existence of a defect based on defect criteria that a defect detect 134 obtained beforehand. The determined result is displayed on a display 126. Processing from the detection of the secondary beams to the determination of a defect is carried out in a parallel manner for each detector.

### Second Embodiment

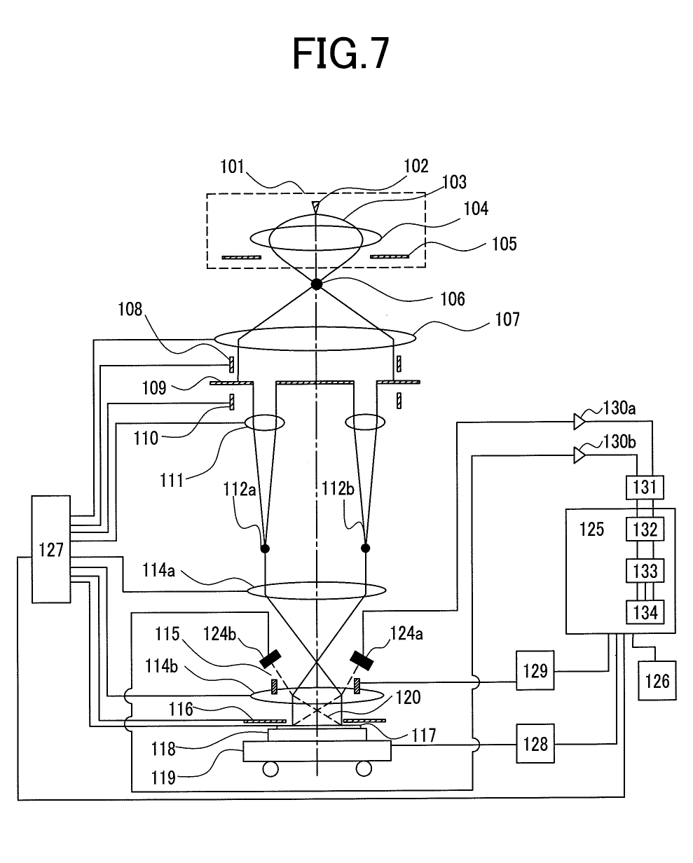

FIG. 7 is a diagram for showing a schematic configuration of a multi-electron-beam inspection apparatus according to a second embodiment of this invention.

The electron gun 101 includes the cathode 102 made of a material whose work function is low, the anode 105 having a high electric potential to the cathode 102, the magnetic lens 104 for superimposing a magnetic field on an acceleration electric field formed between the cathode 102 and the anode 105. For the cathode 102, this example uses the Schottky cathode that easily delivers a large electric current and is also stable in electron emission. The primary beam 103 emitted from the cathode 102 is accelerated in a direction of the anode 105, while receiving a focusing action by the magnetic lens 104.

The reference numeral 106 denotes the first image of source. Using this first image of source 106 as a light source, the condenser lens 107 adjusts the primary beam so as to be substantially collimated. In this embodiment, the condenser lens 107 is a magnetic lens. The reference numeral 109 denotes the aperture array that is formed by arranging openings two-dimensionally and divides the substantially collimated primary beam into a plurality of beams. In this embodiment, the aperture array has four openings substantially equidistant from the central axis, which divides the primary beam into four beams. FIG. 7 illustrates two beams among the four beams. The reference numerals 108, 110 are the aligners each for adjusting positions and angles of the primary beams. The divided primary beams are individually focused by the lens array 111. By this mechanism, the second images of source 112a, 112b are formed.

The reference numerals 114a, 114b are the objective lenses each of which is constructed with two stage magnetic lenses and has an action of reduction projecting the second cathode image 112a (112b) on the specimen 117. The surface field control electrode 116 is an electrode for adjusting the electric field strength near the surface of the specimen 117, and is applied with a positive or negative voltage depending on a voltage applied to the specimen 117.

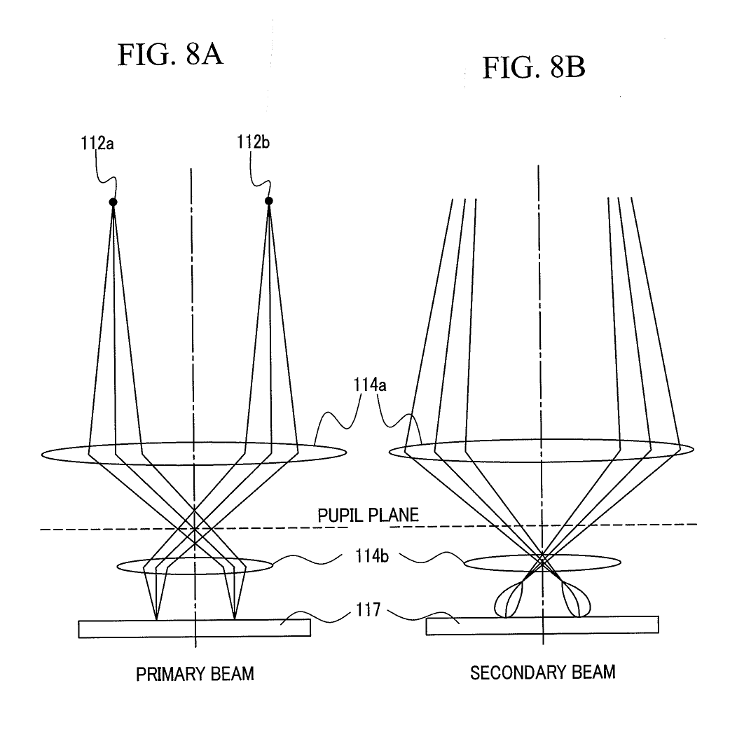

Four primary beams reached the specimen give rise to mutual interaction with a material near the specimen surface, which produces the secondary beam. FIGS. 8A and 8B are diagrams for showing an outline of trajectories of the primary beams and the secondary beams in the objective lens.

FIG. 8A shows trajectories of the primary beams. The objective lenses 114a, 114b reduction project the second images of source 112a, 112b on the specimen 117. What is shown by a dashed line in the figure is a pupil plane. Here, the pupil plane is a plane on which beams emitted from a plurality of object points, i.e., the second images of source 112a, 112b, gather.

On the other hand, FIG. 8B shows trajectories of the secondary beams. The secondary beams produced from the specimen 117 receives acceleration action by a negative voltage applied to the specimen 117, and receives a focusing action by the objective lenses 114a, 114b. At this time, the primary beams and the secondary beams draw different trajectories because of a difference in their energies. For this reason, on the pupil plane of the primary beams shown by the dashed line, the secondary beams produced from a plurality of locations do not gather in one point.

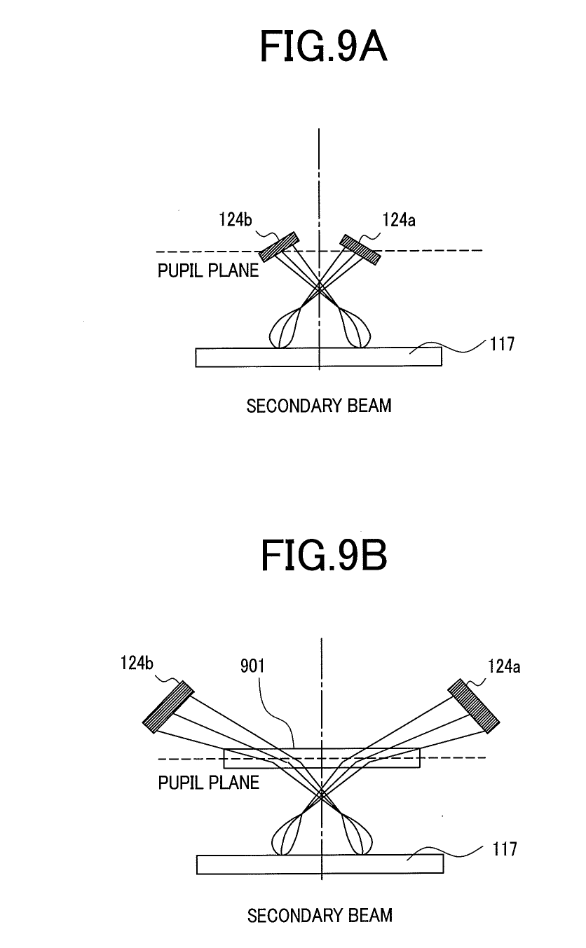

To cope with this problem, in this embodiment, the detectors 124a, 124b are installed on this pupil plane, as shown in FIG. 9A. By this configuration, the secondary beams produced from four locations can be made to reach detectors without interrupting the trajectory of the primary beam being interrupted by detectors and without mutually mixing the secondary beams.

If the detectors are large and make it impossible to set up the configuration of FIG. 9A, what is necessary is to install a secondary beam separator 901 on the pupil plane, adjust the trajectories of the secondary beams so as not to interfere with the primary beam, and detect them with the detectors 124a, 124b. As the secondary beam separator, a deflector array is preferable, for example.

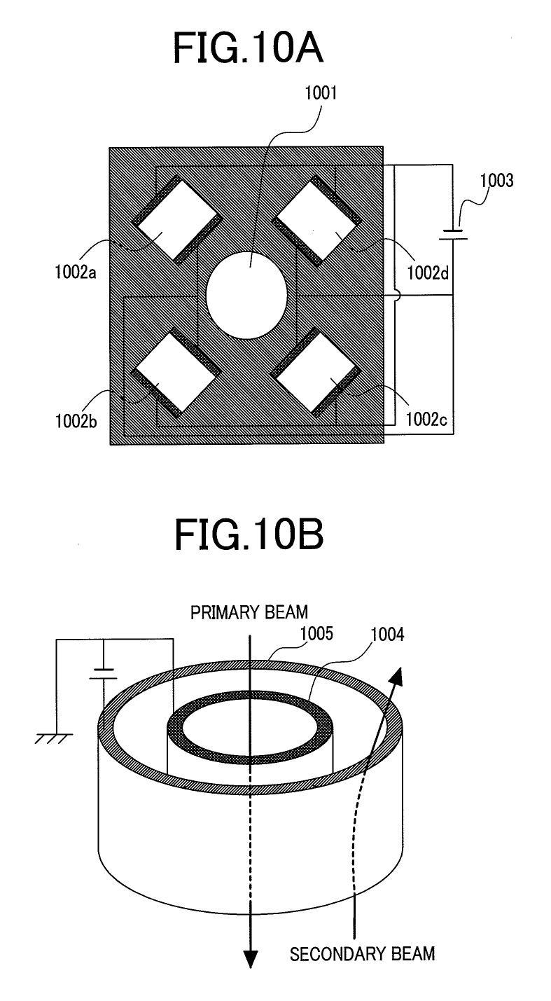

FIG. 10A is a schematic diagram of the deflector array when viewed from a point on the central axis. An opening 1001 for allowing the primary electrons to pass therethrough and openings 1002a, 1002b, 1002c, and 1002d for allowing the secondary beams to pass therethrough are provided on the same plane. The openings 1002a, 1002b, 1002c, and 1002d for allowing the secondary beams to path therethrough are provided with electrodes on their wall surfaces. By applying a voltage to these electrodes using a voltage source 1003 to generate an electric field in the openings 1002a, 1002b, 1002c, and 1002d in a direction perpendicular to the central axis, it is possible to deflect the secondary beams in directions departing from the central axis. On the other hand, the primary beam passes through the opening 1001, without being deflected. By this mechanism, even in the case where the detectors are large, the secondary beams produced from the four locations can be made to reach the detectors without interrupting the trajectory of the primary beam and without mixing mutually.

As an alternative to this method, the following separator may be used. FIG. 10B is a schematic configuration diagram of a cylinder type separator. Two cylinder type electrodes with different inner diameters are arranged on the same axis. A first electrode 1004 located inside is a cylindrical electrode for passing therethrough the primary beam. By connecting this to the earth potential similarly as other parts of the electron optics lens-barrel, the first electrode 1004 allows the primary beam pass in the center to pass therethrough, without deflecting it. On the other hand, similarly, a positive voltage with respect to the first electrode 1004 is applied to a second electrode 1005 located outside. With this configuration, the secondary beams passing through the two electrodes are deflected to a direction departing from the axis.

### Third Embodiment

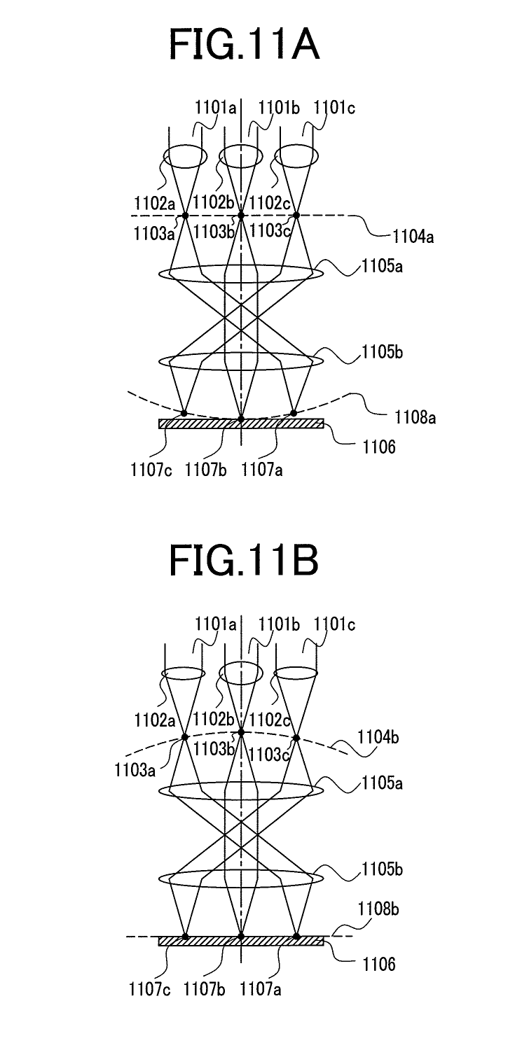

FIGS. 11A and 11B are diagrams for explaining a principle in a third embodiment of this invention.

An alternate long and short dash line is an axis with which a symmetry axis of an objective lens formed in a field of substantially rotation symmetry should coincide, and serves as a standard of a primary beam path. It is hereinafter called the central axis.

In FIG. 11A, a plurality of primary beams 1101a, 1101b, and 1101c form first images 1103a, 1103b, and 1103c by a focusing action of lenses 1102a, 1102b, and 1102c. The lenses 1102a, 1102b, and 1102c are each a part of a plurality of einzel lenses formed in the lens array as shown in FIG. 2.

The first images 1103a, 1103b, and 1103c are formed on the same plane perpendicular to the central axis. Objective lenses 1105a, 1105b treat this plane as an object plane 1104a. Electron beams emitted from the first images 1103a, 1103b, and 1103c are reduction projected on a specimen 1106 by an action of the objective lenses 1105a, 1105b to form second images of source 1107a, 1107b, and 1107c. At this time, an image plane 1108a on which the second images of source 1107a, 1107b, and 1107c are formed is not a plane perpendicular to the central axis. This plane curves in a direction approaching the object plane with increasing distance from the central axis by curvature of image field of the objective lenses 114a, 114b. For this reason, at least one of the plurality of beams 1101a, 1101b, and 1101c cannot form the second image on the specimen 117.

To cope with this problem, as shown in FIG. 11B, focal lengths of the lenses 1102a, 1102b, and 1102c are adjusted so that the object plane 1104b of the object lenses curves in a direction approaching the specimen with increasing distance from the central axis in this invention.

By this adjustment, even if the objective lenses 1105a, 1105b have the curvature of image field, an image plane 1108b is formed on the same plane perpendicular to the central axis. That is, the plurality of beams 1101a, 1101b, and 1101c form the second images of source 1107a, 1107b, and 1107c together on the specimen 117.

In order to realize this, it is necessary to form the first image 1103a, 1103c closer to the objective lens side than the first image 1103b. That is, it is necessary to adjust the focal lengths of the lenses 1102a, 1102c to be longer than the focal length of the lens 1102b. However, in the lens array explained in FIG. 2, the focal lengths of the plurality of lenses are all equal, and accordingly this condition cannot be realized.

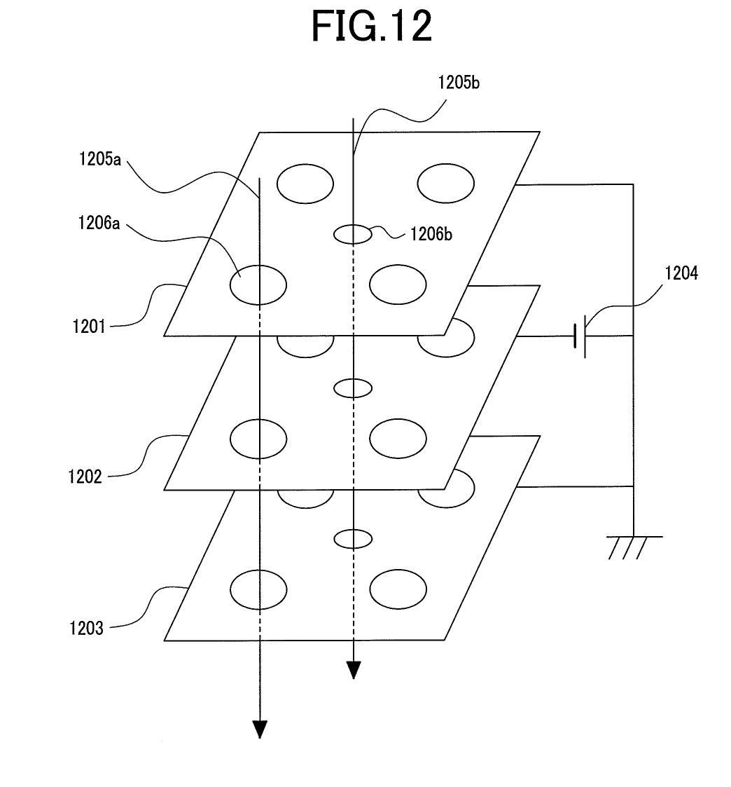

To circumvent this problem, the lens array as shown in FIG. 12 is used in this embodiment. The lens array broadly includes mutually insulated three electrodes of an upper electrode 1201, a middle electrode 1202, and a lower electrode 1203 laminated substantially parallel to one another and each electrode has a plurality of openings. The opening has a circular shape. The openings of the electrodes are aligned on straight lines parallel to the central axis and constitute the einzel lenses. A common potential (in this example, the earth potential) is connected to the upper electrode 1201 and the lower electrode 1203, and a voltage source 1204 is connected to the middle electrode 1202, applying thereto a different potential.

A reference numeral 1205b denotes a central axis, and serves as a path that the beam 1101b in FIGS. 11A and 11B passes through. A numeral 1205a denotes a central axis, and serves as a path that the beam 1101a in FIGS. 11A and 11B passes through. A focal length of the einzel lens is determined by a distance between the electrodes, a voltage applied between the electrodes, and an opening diameter of the electrode. In this embodiment, in order to give different focal lengths to the einzel lens formed on the axis 1205a and the einzel lens formed on the axis 1205b, the openings 1206a, 1206b formed in the electrodes were specified to have different sizes. That is, the diameter of the opening 1206a is specified larger than that of the opening 1206b, whereby a focal length formed on the axis 1205a is intended to be larger than the focal length formed on the axis 1205b.

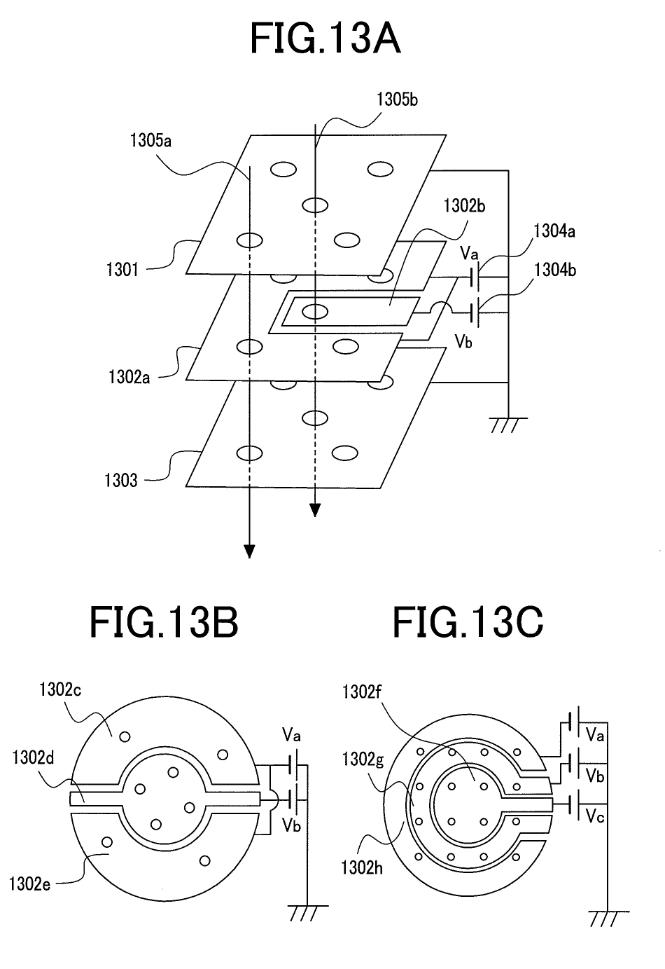

Alternatively, a lens array as shown in FIGS. 13A to 13C may be used. A reference numeral 1305b denotes a central axis, and serves as a path that the beam 1101b in FIGS. 11A and 11B passes through. A reference numeral 1305a denotes a central axis, and serves as a path that the beam 1101a in FIG. 11 passes through. In FIG. 13A, a middle electrode is divided into two partial electrodes 1302a, 1302b that are mutually insulated. An upper electrode 1301 and a lower electrode 1303 are each a single electrode and a common potential (here the earth potential) is connected to the both.

Voltage sources 1304a, 1304b are connected to the middle electrodes 1302a, 1302b divided into two and apply different voltages to them, respectively. By making small an absolute value of the potential Va applied to the electrode 1302a compared with an absolute value of the potential Vb applied to the electrode 1302b, the focal length formed on the axis 1305a is made longer than the focal length formed on the axis 1305b.

Note that although the middle electrode was divided into the two electrodes in FIG. 13A, other division methods than this may be adopted. For example, in the case where eight primary beams are provided with four beams located on the same circle, the following scheme may be adopted: the electrode is divided into three electrodes 1302c, 1302d, and 1302e, as shown in FIG. 13B, the electrodes 1302c, 1302e each for applying voltages to openings that are located equidistant from the central axis are applied with the same voltage. In the case where 4×4 primary beams are provided, the electrode may be divided into three electrodes 1302f, 1302g, and 1302h as shown in FIG. 13C. In this case, absolute values of voltages applied to the electrodes are set so as to be larger with approaching the central axis closer, like Vc<Va<Vb.

By using the above specified lens array, the curvature of image field of the objective lens can be corrected, and accordingly the beams reaching the specimen can be focused excellently.

### Fourth Embodiment

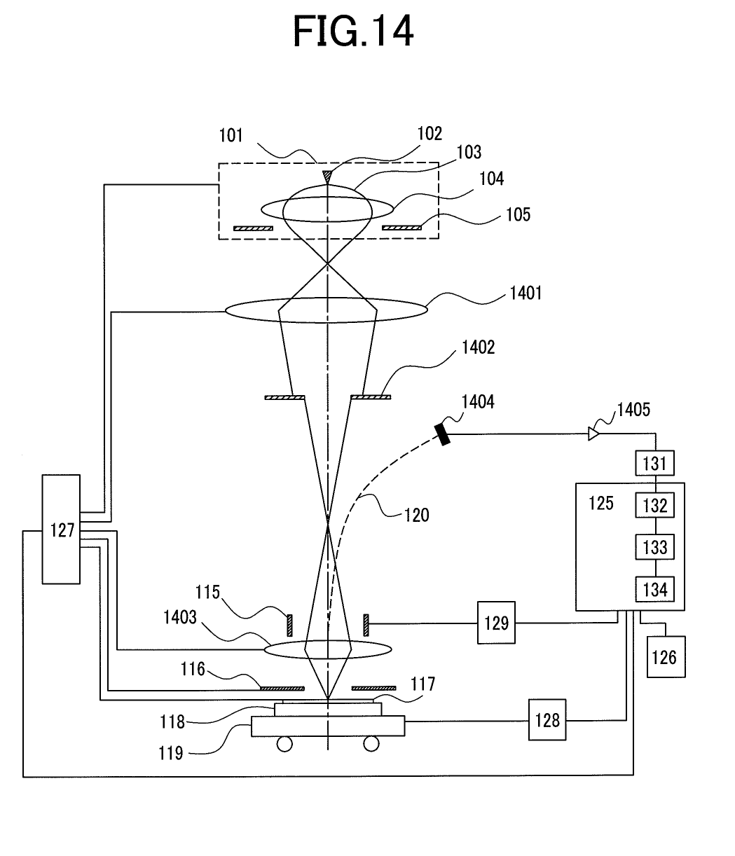

FIG. 14 is a diagram for showing a schematic configuration of a single beam electron beam inspection system according to a fourth embodiment of this invention. The electron gun 101 includes the cathode 102 made of a material whose work function is low, the anode 105 having a high electric potential to the cathode 102, the magnetic lens 104 for superimposing a magnetic field on an acceleration electric field formed between the cathode 102 and the anode 105. Like the first embodiment, this embodiment uses the Schottky cathode that easily delivers a large electric current and is also stable in electron emission. The primary beam 103 emitted from the cathode 102 is accelerated in a direction of the anode 105 and enters a condenser lens 1401 while receiving a focusing action by the magnetic lens 105. The condenser lens 1401 gives the focusing action on the primary beam and controls the amount of the primary beam passing through an opening 1402. The primary beam passing through the opening 1402 is focused by an objective lens 1403 and reaches the specimen 117.

The specimen 117 is placed and held on the movable stage 119 through the pallet 118. The stage 119 is controlled by the stage control 128. Like the first embodiment, the electro static chucking device is built in the inside of the pallet 118, which holds a specimen 117 and corrects it to be the flat chucking plane. Moreover, a negative voltage for decelerating the primary beam is applied to the specimen 117.

The reference numeral 115 denotes the deflector. When a signal is inputted into the deflector 115 by the scanning signal generator 129, the primary beam receives a deflection action and performs raster scan on the specimen.

The secondary beam 120 produced by interaction between the specimen 117 and the primary beam is detected by a detector 1404, and its signal is amplified by an amplifier 1405 and is digitized by the AD converter 131. The digitized signal is temporarily stored in the memory 132 in the system control 125 as image data. Then, the computer 133 calculates various statistics of the image, and, finally the defect detect 134 determines existence/non-existence of a defect based on defect criteria that the defect detect 134 has obtained beforehand. The determination result is displayed on the display 126.

On the other hand, the electron optics control 127 controls the electric field strength in the vicinity of the specimen by applying a voltage to a surface field control electrode 116. For example, the control is done to form an electric field distribution whereby a part of the secondary beam produced from the specimen returns to the surface of the specimen. Alternatively, an electric field distribution such that the secondary beam produced from the specimen may reach the detector 1404 without returning to the specimen surface is formed. Thus controlling the trajectory of the secondary beam 120 enables a charging state of the specimen to be controlled, whereby a high-contrast image can be obtained.

In this embodiment, like the first embodiment, it is made possible to set a distance L between the surface field control electrode and the specimen to 1 mm or less by correcting the specimen to be the flat chucking plane using the electro static chucking device and also by using the height detection mechanism shown in FIG. 4B. Consequently, chromatic aberration and deflection aberration of the primary beam were reduced. Moreover, defect detection sensitivity of a negative electrostatic charge efficiency of the specimen was able to be improved. Moreover, by shortening a time of the secondary beam 120 traveling from the specimen 117 to the detector 1404, temporal resolution of the detection signal was able to be raised and the contrast of an image was able to be improved.

As above, also in a single-beam electron beam inspection apparatus, an effect of enhancing contrast can be obtained by correcting the specimen to be the flat chucking plane using the electro static chucking device, and by setting a distance L between the surface field control electrode and the specimen to 1 mm or less using the height detection mechanism shown in FIG. 4b.

Although in the embodiment described above, the multi-beam and single-beam electron beam inspection apparatuses each using a single electron source were described as examples, the invention is not limited to these examples, but can be applied to a drawing apparatus with a configuration of forming multi beams using a plurality of electron sources. Moreover, this invention is effective when being applied to a multi-beam drawing apparatus that uses a charged particle beam, such as an ion beam, not limited to the electron beam.

As explained in detail above, according to this invention, the charged particle beam apparatus that can realize compatibility between the reduction in aberrations of the primary beam and the separate detection of the secondary beams.

What is claimed is:

1. A charged particle beam apparatus having:
an electron optics that forms a plurality of primary charged particle beams, individually focuses the plurality of primary charged particle beams using a lens array, projects them on a specimen with an objective lens, and makes them scan the specimen with a first deflector;
a plurality of detectors that individually detect a plurality of secondary charged particle beams produced from a plurality of locations of the specimen by the irradiation of the plurality of primary charged particle beams;
a voltage source for applying a voltage to the specimen; and
a stage that places and holds the specimen on it and is movable,
the charged particle beam apparatus further comprising:
a Wien filter for separating a path of the primary charged particle beam and a path of the secondary charged particle beam;
a second deflector for deflecting the secondary charged particle beams separated by the Wien filter; and
control means for controlling the first deflector and the second deflector in synchronization;
wherein the plurality of detectors are configured to individually detect the plurality of secondary charged particle beams that are separated by the Wien filter and are deflected by the second deflector from the plurality of primary charged particle beams.

2. The charged particle beam apparatus according to claim 1, further comprising:
a surface field control that is installed in the vicinity of the specimen and controls the surface field strength of the specimen; and
an electro static chucking device that fixes the specimen on the stage and corrects the flatness of the specimen.

3. The charged particle beam apparatus according to claim 2,
wherein the surface field control electrode has a circular opening that the plurality of charged particle beams pass through, and
a diameter of the opening is one to four times as large as a distance between the surface field control electrode and the specimen.

4. The charged particle beam apparatus according to claim 2,
wherein the surface field control electrode has a plurality of openings that the plurality of charged particle beams individually pass through.

5. A charged particle beam apparatus having:
an electron optics that forms a plurality of primary charged particle beams, individually focuses the plurality of primary charged particle beams with a lens array, projects them on a specimen with an objective lens, and makes them scan the specimen with a deflector;
a plurality of detectors that individually detect a plurality of secondary charged particle beams produced from a plurality of locations of the specimen by irradiation of the plurality of primary charged particle beams; and
a voltage source for applying a voltage to the specimen,
the charged particle beam apparatus further comprising separation means for separating the primary charged particle beams and the secondary charged particle beams on a pupil plane of the electron optics,
wherein the plurality of detectors are configured to individually detect the plurality of secondary charged particle beams separated by the separation means.

6. The charged particle beam apparatus according to claim 5,
wherein the separation means is a deflector array provided on the same substrate, and
the substrate has a first opening that the primary charged particle beam passes through and a plurality of openings that are arranged around the first opening and the secondary charged particle beams pass through.

7. The charged particle beam apparatus according to claim 5,
wherein the separation means includes a first tubular electrode and a second cylindrical electrode provided inside the first tubular electrode,
central axes of the first tubular electrode and the second cylindrical electrode are substantially the same, and
different voltages can be applied to the first tubular electrode and the second cylindrical electrode, respectively.

8. A charged particle beam apparatus having:
an electron optics that forms a plurality of primary charged particle beams, individually focuses the plurality of primary charged particle beams with a lens array, projects them on the specimen with an objective lens, and makes them scan the specimen with a deflector;
a plurality of detectors that individually detect a plurality of secondary charged particle beams produced from a plurality of locations of the specimen by irradiation of the plurality of charged particle beams; and
a voltage source for applying a voltage to the specimen,
wherein the plurality of detectors are arranged on a pupil plane of the electron optics and are configured to individually detect the plurality of secondary charged particle beams.

9. The charged particle beam apparatus according to any of claims 1, 5, and 8,
wherein the objective lens is disposed to form a field of substantially a rotational symmetry around its central axis,
the lens array includes mutually insulated three electrodes that are laminated substantially in parallel,
each of the three electrodes has a plurality of openings that the plurality of primary charged particle beams pass through,
a middle electrode sandwiched by the remaining two electrodes in the three electrodes is divided into mutually insulated first partial electrode and second partial electrode,
the first partial electrode is equipped with a first opening and a second opening, the second partial electrode is equipped with a third opening, and
a distance between the first opening and the central axis is substantially the same as a distance between the second opening and the central axis and is different from a distance between the third opening and the central axis.

10. The charged particle beam apparatus according to any of claims 1, 5, and 8,
wherein the objective lens is arranged to form a field of substantially rotation symmetry around its central axis,
the lens array includes a plurality of mutually insulated electrodes that are laminated substantially parallel to one another,
each of the plurality of electrodes has a plurality of openings, and
sizes of the openings formed on at least one electrode among the plurality of electrodes are different depending on a distance to the central axis.

11. The charged particle beam apparatus according to either claim 5 or claim 8, further comprising:
a surface field control that is installed in the vicinity of the specimen and controls the surface field strength of the specimen; and
an electro static chucking device that fixes the specimen on the stage and corrects the flatness of the specimen.

12. A charged particle beam apparatus having:
a charged particle gun for generating and accelerating a primary charged particle beam;
a lens for focusing the primary charged particle beam;
an objective lens for focusing the primary charged particle beam on a specimen;
a deflector for scanning the primary charged particle beam on the specimen,
a detector for detecting secondary charged particles produced by the primary charged particle beam colliding against the specimen;
a voltage source for applying a voltage to the specimen; and
a stage that places and holds the specimen and is movable,
the charged particle beam apparatus further comprising:
a surface field control electrode that is installed in the vicinity of the specimen and controls the surface field strength of the specimen;
a voltage source for applying a voltage to the surface field strength control electrode; and
an electro static chucking device that fixes the specimen on the stage and corrects the flatness of the specimen.
